(19) United States
(12) Patent Application Publication
(10) Pub. No.: US 2015/0212022 A1
(43) Pub. Date: Jul. 30, 2015

(54) METHOD AND APPARATUS FOR DETERMINING A STRENGTH PROFILE OF MATERIALS

(71) Applicant: SCHLUMBERGER TECHNOLOGY CORPORATION, Sugar Land, TX (US)

(72) Inventors: Vladimir Victorovich Abashkin, Moscow (RU); Dmitry Evgenievich MIKLASHEVSKY, Kaluga (RU)

(21) Appl. No.: 14/575,293

(22) Filed: Dec. 18, 2014

(30) Foreign Application Priority Data
Dec. 18, 2013 (RU) 2013156002

(51) Int. Cl. G01N 25/72; G01K 7/02; G01J 5/12

(52) U.S. Cl. CPC G01N 25/72; G01J 5/12; G01K 7/02

(57) ABSTRACT

A sample surface is heated and scratched by a cutter. During scratching, horizontal and vertical components of a force with which the heated sample resists to destruction by the cutter are measured. A sample temperature in a heating zone where the cutter and the sample surface contact each other is measured during the heating. The heating temperature can be adjusted, if necessary. An apparatus for determining a strength profile of materials comprises a platform for placing at least one sample, a measurement unit comprising a cutter to scratch a sample surface, a heating source for heating the cutter and a means for measuring a temperature in the heating zone where the cutter and the sample surface contact each other. The platform for placing at least one sample and the measurement unit are movable relative to each other.

### CROSS-REFERENCE TO RELATED APPLICATION

This application claims priority to Russian Application No. 2013156002 filed Dec. 18, 2013, which is incorporated herein by reference in its entirety

### BACKGROUND

The invention relates to the field of studying mechanical properties of materials.

To solve multiple scientific and technological problems, information on mechanical properties of materials under atmospheric thermobaric conditions and at elevated temperatures is necessary, for example, mechanical properties (an ultimate compression strength, a Young's modulus, a Poisson's ratio) of mountain rocks are key parameters in the oil and gas industry when designing and estimating risks of such processes as drilling, cementing, hydraulic fracturing of formation, stimulating of oil production by steam drive, etc.,

Mechanical properties of materials at elevated temperatures H pressures can be measured by heated high-pressure cells capable of uniaxial, biaxial and true triaxial compression (cf., ASTM D7012-10 Standard Test Method for Compressive Strength and Elastic Moduli of Intact Rock Core Specimens under Varying States of Stress and Temperatures). The main disadvantage of the present technique is a high duration and accordingly a high cost of the experiment due to core holder heating/cooling times. Depending upon a sample size and a type of a high-pressure cell, a time necessary for heating/cooling can vary from several hours up to several days. Prior to measurements by this technique, a sample of a material should be machined qualitatively to provide the parallelism of working surfaces. In case of studying inhomogeneous geomaterials for the oil and gas industry, this technique also requires a sufficient quantity of a core material to generate a representative collection. Said aspects of the technique result in a significant time consumption to use of said technique for studying quantitatively representative samples of material collections.

Methods and different apparatuses for determining a profile of mechanical properties of materials by scratching at a room temperature are known as well (for example, U.S. Pat. No. 8,234,912 or U.S. Pat. No. 7,302,831). However, the present methods give no chance to study strength properties of materials under conditions of an elevated temperature though, as experimental studies show, the elevated temperature is one of the most important parameters the mechanical properties of materials depend upon (cf., P. J. Closmann, W. B. Bradley, “The Effect of Temperature on Tensile and Compressive Strengths and Young's Modulus of Oil Shale”, SPE Journal, Vol. 19, #5, pp. 301-312, 1979, or ASTM D1043-10 “Standard Test Method for Stiffness Properties of Plastics as a Function of Temperature by Means of a Torsion Test”).

### SUMMARY

The disclosure provides for improved accuracy and effectiveness of determining the mechanical properties of materials through determination of a strength profile of a material by scratching the material under study at elevated temperatures.

Method for determining a strength profile of a material comprises moving a sample of the material and a cutter relative to each other, heating a surface of the sample during the movement and scratching the heated surface of the sample by the cutter. The strength of the sample is determined by measuring horizontal and vertical components of a force with which the heated sample resists to destruction by the cutter. A sample temperature is measured in a heating zone where the cutter and the sample surface contact each other during the heating and the heating temperature is adjusted, if necessary.

The heating of the sample surface is carried out in the immediate vicinity of the cutter during the movement of the sample and a heating source relative to each other, while the adjusting of the heating temperature is carried out by adjusting a power of the heating source or by focusing a radiation of the heating source.

In order to provide a necessary temperature of the sample, the power of the heating source and a movement velocity can be set preliminary.

The sample temperature can be measured continuously or discretely.

The sample temperature in the heating zone where the cutter and the sample surface contact each other can be measured in a contactless manner.

In accordance with one of embodiments of the disclosure, the cutter is heated. During the heating of the cutter a temperature of the cutter is measured and the cutter temperature is adjusted, if necessary.

In accordance with one of embodiments of the disclosure, the cutter can be heated in a contact manner, for example, by a built-in heater.

In accordance with another embodiment of the disclosure, the heating is carried out by a contactless heating source. The adjustment of the heating temperature is carried out by adjusting the heating source power or by varying a focus distance and/or radiation geometry of the heating source.

The cutter temperature can be measured by a contact temperature sensor disposed on a cutter surface.

The cutter temperature and/or the sample surface temperature can be measured in a contactless manner.

The cutter temperature can be measured continuously or discretely.

In accordance with still another embodiment of the disclosure, the sample surface can be covered by a layer of a material completely absorbing an energy radiated by the heating source. A black paint can be used as such a material.

A mountain rock core can be used as the sample of the material under study.

To implement the disclosed method for determining a strength of materials, an apparatus can be used comprising a platform for disposing at least one sample, a measurement unit comprising a cutter for scratching a sample surface, a heating source for heating the cutter; a means for measuring a temperature of the sample in the heating zone where the sample and the cutter contact each other, and a means for determining the strength by measuring horizontal and vertical components of a force with which the heated sample resists to the cutter, wherein the platform for disposing at least one sample and the measurement unit are movable relative to each other. The heating source can provide the heating of the sample in the immediate vicinity of the cutter.

The heating source can have an arbitrary shape (for example, it can be a point one, a linear one, a strip one) and can be oriented in an arbitrary direction relative to a movement velocity vector.

For example, it is possible to use a laser as the point heat source. The apparatus can further include a heating source radiation focusing unit for adjusting a heating power density as well as a source radiation spot shape on the surface of the material sample to implement the heating by a linearly elongated source.

The apparatus can be further provided with a movement velocity variation means.

In accordance with one of embodiments of the disclosure, a contactless optical temperature sensor or an infrared imager is used as the means for measuring the temperature in the heating zone where the cutter and the sample surface contact each other. An infrared sensor can be used as the optical sensor.

In accordance with a still another embodiment of the disclosure, the apparatus can further include a cutter heating means and a cutter temperature measurement means.

A built-in contact heater or an additional independent moving heating source can be used as the cutter heating means.

In accordance with other embodiment of the disclosure, the means for measuring the sample temperature in the heating zone where the sample contacts the cutter can be used as the cutter temperature measurement means.

### BRIEF DESCRIPTION OF DRAWINGS

The invention is explained by the drawings, wherein FIG. 1 shows a scheme of the apparatus for implementing the material strength profile determining method;

FIG. 2a shows a geometry for a temperature rise distribution estimate, the temperature rise being caused by a point heating source;

FIG. 2b shows a geometry for a temperature rise distribution estimate, the temperature rise being caused by a linear heating source;

FIG. 3 shows example of results of estimation of temperature variations with scratching depth increase.

### DETAILED DESCRIPTION

The method is based on measurement of a sample strength by scratching a heated area. To implement the method, it is possible to use an apparatus comprising: a platform 1 with at least one material sample 2 disposed thereon and mounted in a holder 3, and a measurement unit that comprises a cutter 4, a contactless heating source 5, for example, a laser focused on the surface of the sample 2 in the immediate vicinity of the cutter 4, and a means for measuring a temperature of the sample 2 in a heating zone where the cutter contacts the sample surface. Said temperature measurement means can be either a pair of optical sensors that measure the temperature of the sample 2 prior to the heating (a sensor 6) and after the heating in the immediate vicinity of the cutter (a sensor 7), or an infrared imager 8 recording a temperature distribution in an area of the surface of the sample 2 within the heating zone where the cutter 4 and the surface of the sample 2 contact each other. The apparatus also comprises a force sensor 9 for measuring horizontal and vertical components of a force with which the sample 2 resists to destruction by the cutter 4, a motor 10 for moving the cutter 4 and the measurement unit relative to each other at a predetermined velocity, an electronic unit 11 for automatic measurements and coupling of the sensors with a control device 12. An incandescent lamp etc. can be also used as the point heating source.

In accordance with one of embodiments of the disclosure, the apparatus can be further provided with a cutter heating means and a cutter temperature measurement means, for example a built-in contact heater (not shown in the drawing) or an additional independent moving heating source (not shown in the drawing).

The cutter temperature is measured, for example, by a contact temperature sensor 13 or an additional optical sensor (not shown in the drawing) pointed at the cutter 4, or by the infrared imager 8 recording a temperature in the surface area which includes the zone where the sample 2 and the cutter 4 contact each other.

Next, one of embodiments of the method for determining the strength of a material will be described as an example, said method comprising moving the measurement unit relative to a surface of a sample. At least one sample 2 of the material under study, for example a mountain rock core, is mounted into the holder 3 on the platform 1. The surface of the sample 2 should meet the requirements of a measurement procedure for scratching.

A necessary heating temperature is set on the basis of exploitation temperatures/natural conditions of the material under study. Prior to the measurement of the strength, a necessary power of the heating source 5 and its movement velocity are determined to provide a necessary temperature for heating the sample 2. It is possible to estimate the heating source temperature by moving the measurement unit at a predetermined velocity along the sample 2 without scratching thereof and measuring a surface temperature of the sample 2 in a region that includes a focus of the optical heating source 5, i.e., a heating zone and a zone of future contact of the cutter 4 with the material sample 2.

In case of significant variations in a temperature of the sample volume under study, in order to align optical characteristics (heating radiation absorption and reflection coefficients of the heating source) of the material, it is necessary to cover the surface of the sample 2 by a layer of a material necessary for complete absorption of the energy radiated by the heating source, the layer having a minimum possible thickness. A black paint can be used as such an absorption material

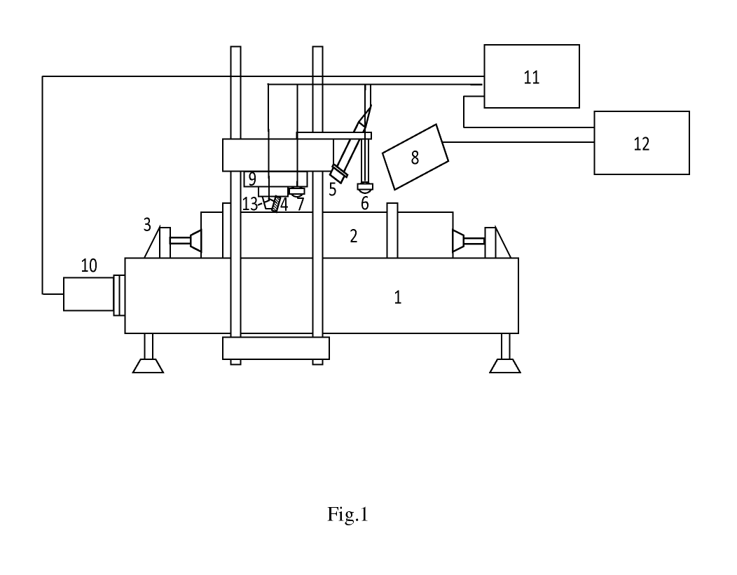

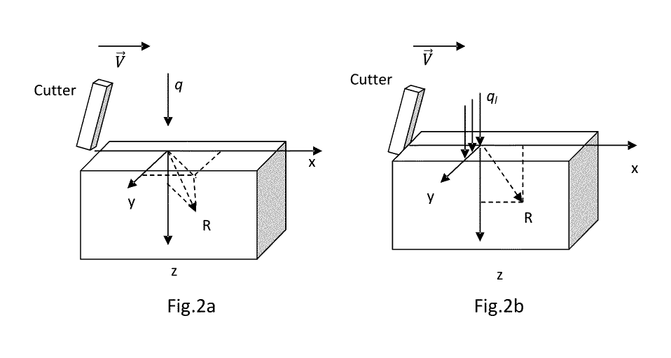

To provide heating of the surface of the sample 2 at a temperature differential along a cut depth not greater than a predetermined differential, a scratching depth and a distance between a hot spot provided by the optical heating sensor 5 and the region where the cutter 4 contacts the surface of the material sample 2 are estimated using, for example, the following formulae which describe the heating of a sample by a point heating source moving along an x-axis, and by a linearly elongated heating source which moves along the x-axis as well:

$$\begin{matrix}θ ( x , y , z ) = \frac{q}{2 πλ R} exp ( - \frac{v ( x + R )}{2 a} ) ; & ( 1 ) \\ θ ( x , R ) == \frac{{q}_{1}}{2 {π}^{1 / 2} λ} {( \frac{a}{vR} )}^{1 / 2} exp ( - \frac{v ( x + R )}{2 a} ) , & ( 2 )\end{matrix}$$

where v is a heating source movement velocity; q is an amount of energy absorbed by the sample in a point of the surface; qₗ is a linear power density of a linearly elongated heating source, said power having been absorbed by the surface of the sample; λ is a thermal conductivity of the sample; θ is an excessive temperature characterizing a difference in sample surface temperatures before the heating (a temperature measured, for example, by the sensor 6) and after the heating (a temperature measured by the sensor 7 in the zone where the sample is heated in the immediate vicinity of the cutter), a is a thermal diffusivity of the material sample, R=\sqrt{x²+y²+z²}, where x, y, z are coordinates of a point within a volume of the sample (see FIG. 2). FIG. 2a shows a geometry for a temperature rise distribution estimate, where Cutter moves at constant velocity V, along axis x, with axis y oriented along the sample surface perpendicular to the V direction, and axis z perpendicular to sample surface and directed into the sample body, the temperature rise at the sample point characterized by radius-vector R, being caused by a point heating source q; FIG. 2b shows a geometry for a temperature rise distribution estimate, where Cutter moves at constant velocity V, along axis x, with axis y oriented along the sample surface perpendicular to the V direction, and axis z perpendicular to sample surface and directed into the sample body, the temperature rise at the sample point characterized by radius-vector R, being caused by a point linear heating source qₗ.

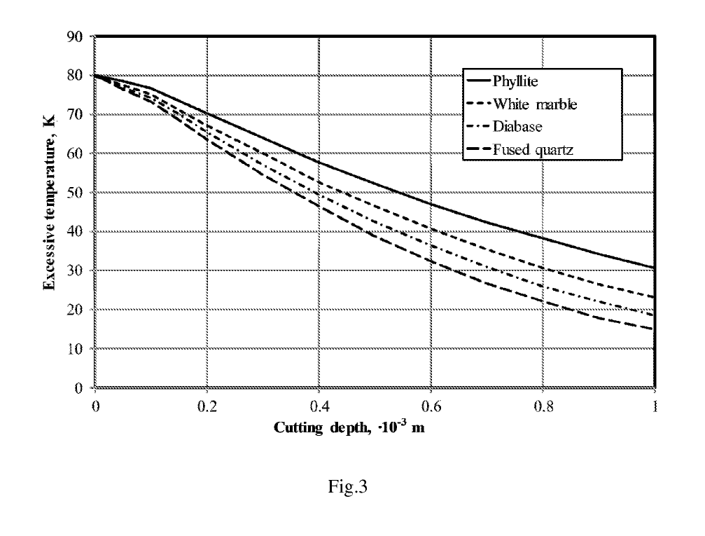

According to the formulae 1-2 and similar formulae which describe a distribution of excessive temperatures within a volume of the sample during the heating by a heating energy source of a known shape and knowing thermal properties of the sample (Table 1), we can estimate a variation of a heating depth with cutting depth increase (FIG. 3) to provide the heating of the sample volume with a temperature differential along a cut depth not more than a predetermined variation, and thereby provide a reliable physical simulation of a test for a material heated uniformly. The temperature differential is determined on the basis of a necessary accuracy of the material heating-up experiment.

Thus, a relative variation of the sample temperature along the material cutting depth (0.2 mm is the most commonly used) at the measurement unit movement velocity of 5 mm/s and the distance of 1 mm between the point heating source and the cutter is less than 20% if the excessive temperature of the material surface is 80° C.

TABLE 1

| # | Material | λ, W/(m · K) | a, 10⁻⁶ m²/s |
|---|---|---|---|
| 1 | Fused quartz | 1.35 | 0.827 |
| 2 | Diabase | 2.30 | 1.06 |
| 3 | White marble | 3.15 | 1.41 |
| 4 | Phyllite | 4.85 | 2.36 |

The heating source 5 and the cutter 4 are moved along the surface of the sample 2 of the material under study. The heating source 5 heats the sample 2 in the immediate vicinity (for example within 1 mm) of the cutter 4 used to scratch the heated surface of the sample 2.

The temperature of the sample 2 is measured in the heating zone where the cutter contacts the sample surface, and the heating temperature is adjusted, if necessary. The temperature measurements can be continuous or discrete.

Further, the cutter 4 can be heated, and the temperature thereof can be measured. The temperature of the cutter 4 can be measured by measuring the temperature of the cutter surface by a contact temperature sensor 13 positioned on the cutter surface. A thermocouple or a resistive temperature transducer can be used as the contact temperature sensor 13.

The temperature of the sample 2 in the heating zone and the temperature of the cutter 4 are measured by the optical sensor 7 or the infrared imager 8. An infrared sensor can be used as the optical sensor 7.

The heating temperature can be adjusted by adjusting the power of the heating source 5. A laser can be used as the heating source, wherein the apparatus can further include a laser radiation focusing unit to adjust the heating power and a shape of a laser radiation spot on the surface of the material sample.

The apparatus can be further provided with a heating source movement velocity measurement unit (not shown in the drawing).

The focus distance of the heating source 5 is adjusted to produce a necessary power of the source on the surface of the 1 sample 2 to provide the heating of the sample 2 at a temperature differential along the cutting depth not more than the predetermined differential.

The strength of the material is measured by measuring horizontal and vertical components of a force with which the sample 2 heated by the heating source 5 up to the necessary temperature resists to destruction by the cutter 4 deepened relative to the surface of the sample 2 at a known depth and moving at a predetermined velocity (cf., F. Dagrain, J. P. Tshibangu, “Use of the 3D model for the estimation of forces acting on a cutter in rock cutting”, SPE/ISRM Rock Mechanics Conference, Irving, Tex., SPE78242, October, 2002).

1. A method for determining a strength profile of a material, the method comprising:
moving a sample of the material and a cutter relative to each other;
heating a surface of the sample by a heating source during the movement and scratching the heated surface of the sample using the cutter;
during the heating, measuring sample temperature in a heating zone where the cutter and the sample surface contact each other; and
determining a strength of the sample by measuring horizontal and vertical components of force with which the sample resists scratching by the cutter.

2. The method of claim 1, wherein the heating of the sample surface is carried out in the immediate vicinity of the cutter during movement of the sample and the heating source relative to each other.

3. The method of claim 1, wherein a power of the heating source and a movement velocity are set preliminarily in order to generate a specific temperature of the sample.

4. The method of claim 1, wherein the sample temperature is measured continuously.

5. The method of claim 1, wherein the sample temperature is measured discretely.

6. The method of claim 1, wherein the sample temperature is measured in a contactless manner in the heating zone where the cutter and the sample surface contact each other.

7. The method of claim 1, further comprising heating the cutter and measuring a temperature of the cutter during the heating.

8. The method of claim 7, wherein a temperature of the cutter is adjusted.

9. The method of claim 7, wherein the cutter is heated by a built-in contact heater.

10. The method of claim 7, wherein the cutter is heated by an additional independent heating source.

11. The method of claim 7, wherein the temperature of the cutter is measured by a contact temperature sensor disposed on a cutter surface.

12. The method of claim 7, wherein the temperature of the cutter is measured in a contactless manner.

13. The method of claim 7, wherein the temperature of the cutter is measured continuously.

14. The method of claim 7, wherein the temperature of the cutter is measured discretely.

15. The method of claim 1, wherein the surface of the sample is covered by a layer of a material completely absorbing an energy radiated by the heating source.

16. The method of claim 15, wherein a black paint is used as the material completely absorbing the energy radiated by the heating source.

17. The method of claim 1, wherein a mountain rock core is used as the sample of the material under study.

18. The method of claim 1, wherein a temperature of the sample surface is adjusted.

19. The method of claim 18, wherein the adjustment of the temperature is carried out by adjusting a power of the heating source.

20. The method of claim 18, wherein the adjustment of the temperature is carried out by varying a focus distance and/or a radiation geometry of the heating source.

21. An apparatus for determining a strength profile of materials, the apparatus comprising:
a platform for placing at least one sample;
a measurement unit comprising a cutter for scratching a surface of the sample, wherein the measurement unit and the platform are movable relative to each other;
a heating source for heating the sample;
a means for measuring a temperature in the heating zone where the cutter and the sample surface contact each other; and
a means for determining the strength of the sample by measuring horizontal and vertical components of a force with which the heated sample resists scratching by the cutter.

22. The apparatus of claim 21, wherein the heating source provides the heating of the sample in the immediate vicinity of the cutter.

23. The apparatus of claim 21, wherein the heating source is a point heating source.

24. The apparatus of claim 21, wherein the heating source is a linear heating source oriented in an arbitrary direction relative to a movement velocity vector.

25. The apparatus of claim 21, wherein the heating source is a strip heating source oriented in an arbitrary direction relative to a movement velocity vector.

26. The apparatus of claim 21, wherein a laser is used as the heating source.

27. The apparatus of claim 26, further comprising a laser radiation focusing unit for adjusting a heating power density.

28. The apparatus of claim 21, further comprising a velocity variation means for movement of the sample.

29. The apparatus of claim 21, wherein a contactless optical temperature sensor is used as the means for measuring the temperature in the heating zone where the cutter and the sample surface contact each other.

30. The apparatus of claim 21, wherein an infrared sensor is used as the contactless optical temperature sensor.

31. The apparatus of claim 21, wherein an infrared imager is used as the means for measuring the temperature in the heating zone where the cutter and the sample surface contact each other.

32. The apparatus of claim 21, further comprising a means for heating the cutter and a means for measuring a temperature of the cutter.

33. The apparatus of claim 32, wherein a built-in contact heater is used as the means for heating the cutter.

34. The apparatus of claim 32, wherein an additional independent heating source is used as the means for heating the cutter.

35. The apparatus of claim 32, wherein a contact temperature sensor mounted on the surface of the cutter in the immediate vicinity to the sample surface is used as the means for measuring the temperature of the cutter.

36. The apparatus of claim 35, wherein a thermocouple or thermal resistance transducer is used as the contact temperature sensor.

37. The apparatus of claim 32, wherein the means for measuring a temperature of the sample in the heating zone and in the zone where the cutter contact the sample surface is used as the means for measuring the temperature of the cutter.
